(19) United States
(12) Patent Application Publication
(10) Pub. No.: US 2011/0276768 A1
(43) Pub. Date: Nov. 10, 2011

(54) I/0 COMMAND HANDLING IN BACKUP

(75) Inventors: Benny KOREN, Zikhron Ya'aqov (IL); Erez ZILBER, Zichron Yaakov (IL); Shachar FIENBLIT, Ein Ayala (IL); Guy KEREN, Haifa (IL); Yedidia ATZMONY, Omer (IL)

(73) Assignee: KAMINARIO TECHNOLOGIES LTD., Yokne'am ILIT (IL)

(21) Appl. No.: 13/101,403

(22) Filed: May 5, 2011

Related U.S. Application Data
(60) Provisional application No. 61/332,987, filed on May 10, 2010.

(51) Int. Cl. G06F 12/02

(52) U.S. Cl. 711/154; 711/E12.002

(57) ABSTRACT

Systems and methods for input/output command management. In some cases of a write command received from a host, a maximum capacity limit relating to primary memory may be disregarded because data relating to the write command is written to backup memory prior to acknowledging the write command. In some of these cases, timeout is less likely than if the maximum capacity limit had been respected.

### FIELD OF THE INVENTION

The present invention relates to the field of storage.

### BACKGROUND OF THE INVENTION

A typical storage system includes one or more controllers, one or more primary memory storage entities, and/or one or more backup memory storage entities. When a host sends a write command to the storage system, the host expects to receive an acknowledgement of the write command prior to a timeout limit set by the host. If the timeout limit is exceeded, the command may be deemed a failure by the host.

### SUMMARY OF THE INVENTION

According to some embodiments of the invention, there is provided a method of managing write commands in a storage system, comprising: receiving a write command; determining whether or not primary memory has sufficient vacancy to write data relating to the command; if the primary memory does not have sufficient vacancy, then determining whether or not to limit waiting for vacancy to become sufficient; and if determined to limit waiting and if the limit has been exceeded then after the limit has been exceeded: writing data relating to the command to backup memory; and acknowledging success for the write command after the data has been written to the backup memory.

According to the present invention, there is also provided a method of managing write commands in a storage system, comprising: receiving a write command; determining that primary memory does not currently have sufficient vacancy to write data relating to the received write command; determining that a likelihood of a time period exceeding a timeout allowed for the storage system, is greater than a predetermined threshold, wherein the time period includes time for waiting until there is sufficient vacancy, writing data relating to said command, and acknowledging the write command; prioritizing performance of the write command by limiting time that the write command waits for vacancy in the primary memory to become sufficient; and after the limit has expired, writing data relating to the command to backup memory, and acknowledging the write command.

According to the present invention, there is further provided a system for managing a write command, comprising: a host interface for receiving a write command; an occupancy manager for determining whether or not primary memory has sufficient vacancy to write data relating to the command, and if the primary memory does not have sufficient vacancy, then for determining whether or not to limit waiting for vacancy to become sufficient; a timer manager for determining if the limit has been exceeded, if determined to limit waiting; an interface to backup memory for writing data relating to the command to backup memory, after the limit has been exceeded, if the limit has been exceeded; wherein the interface to host is also configured to acknowledge success for the write command after the related data has been written to the backup memory.

According to the present invention, there is further provided a computer readable medium having a computer readable code embodied therein for managing write commands in a storage system, the computer readable code comprising instructions for: receiving a write command; determining whether or not primary memory has sufficient vacancy to write data relating to said command; if said primary memory does not have sufficient vacancy, then determining whether or not to limit waiting for vacancy to become sufficient; and if determined to limit waiting and if said limit has been exceeded then after said limit has been exceeded: (a) writing data relating to said command to backup memory; and (b) acknowledging success for said write command after said data has been written to said backup memory.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a high level block diagram of a system for generating and managing write commands, according to some embodiments of the invention;

FIG. 2 is a more detailed block diagram of the command executor of FIG. 1, according to some embodiments of the invention; and

FIG. 3 (comprising FIGS. 3A and 3B) is a flowchart illustration of a method for managing write commands, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In embodiments of the present invention, write commands are performed differently in a storage system under differing conditions. For example, in some cases a maximum capacity limit relating to primary memory may be disregarded because data relating to the write command is written to backup memory prior to acknowledging the write command. In some of these embodiments, a lowered risk of timeout results.

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as not to obscure the present invention.

As used herein, the phrase “for example,” “such as”, “for instance” and variants thereof describe non-limiting embodiments of the present invention.

Reference in the specification to “one embodiment”, “an embodiment”, “some embodiments”, “another embodiment”, “other embodiments”, “one instance”, “some instances”, “one case”, “some cases”, “other cases” or variants thereof means that a particular feature, structure or characteristic described in connection with the embodiment(s) is included in at least one embodiment of the invention. Thus the appearance of the phrase “one embodiment”, “an embodiment”, “some embodiments”, “another embodiment”, “other embodiments” one instance”, “some instances”, “one case”, “some cases”, “other cases” or variants thereof does not necessarily refer to the same embodiment(s).

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Unless specifically stated otherwise, as apparent from the following discussions, it is appreciated that throughout the specification discussions utilizing terms such as “receiving”, “determining”, “writing”, “limiting”, waiting”, “acknowledging”, “allowing”, “decreasing”, “increasing”, “erasing”, “calculating”, “backing up”, “causing”, “locking”, “prioritizing”, “managing”, “queuing”, “powering”, or the like, refer to the action and/or processes of any combination of software, hardware and/or firmware. For example, these terms may refer in some cases to the action and/or processes of a computer or computing system, or similar electronic computing device, that manipulates and/or transforms data represented as physical, such as electronic quantities, within the computing system's registers and/or memories into other data similarly represented as physical quantities within the computing system's memories, registers or other such information storage, transmission or display devices.

Embodiments of the present invention may include apparatuses for performing the operations herein. Each of these apparatuses may be specially constructed for the desired purposes, or may comprise a general purpose computer selectively activated or reconfigured by a computer program stored in the computer. Such a computer program may be stored in a computer readable storage medium, such as, but not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not necessarily inherently related to any particular computer or other apparatus. Various general purpose systems may in some cases be used with programs in accordance with the teachings herein, or it may in other cases prove convenient to construct a more specialized apparatus to perform the desired method. Possible structures for a variety of these systems will appear from the description below. In addition, embodiments of the present invention are not described with reference to any particular programming language. It will be appreciated that a variety of programming languages may be used to implement the teachings of the inventions as described herein.

In the description of the present invention, reference is made to the term “storage segment” or simply to “segment”. Unless explicitly stated otherwise, the term “storage segment”, “segment” or variants thereof shall be used to describe a physical unit that is accessed as a unit from storage. For example, in one type of storage, each block may be a separate storage segment. However this example should not be construed as limiting, and storage segments may be of any size, and even of different sizes within storage.

In the description of the present invention, reference is made to the term “write command”, or simply to “command”. Unless explicitly stated otherwise, the term “write command”, “command”, or variants thereof shall be used to describe a write instruction which refers to one or more storage segments. Typical types of write commands include a write command that commands the storing of data within storage or the updating of existing data within storage. A write command is an example of a command which changes the content in storage (“content changing command”). It would be appreciated, that many storage interface protocols include different variants on the write commands, but often such variants are essentially some form of the basic write commands. Examples of storage interface protocols include inter-alia: Small Computer System Interface (SCSi), Fibre Channel (FC), Fibre Channel over Ethernet (FCoE), Internet SCSI (iSCSI), Serial Attached SCSI (SAS), Enterprise System Connectivity (ESCON), Fibre Connectivity (FICON), Advance Technology, Attachment (ATA), Serial ATA (SATA), Parallel ATA (PATA), Fibre ATA (FATA), ATA over Ethernet (AoE). By way of example, the SCSI protocol will be referred to below even though other protocols may be used. The SCSI protocol supports write commands on different block sizes, but it also has variants such as the verify command which is defined to read data and then compare the data to an expected value. Further by way of example, the SCSI protocol supports a write-and-verify command which is effective for causing the storage of the data to which the command relates, the reading of the stored data, and the verification that the correct value was stored.

In the description of the present invention, reference is made to the term “volatile memory storage”. The terms “volatile memory storage” and variants thereof, unless explicitly stated otherwise, are used to describe a component which includes one or more data retention modules whose storage capabilities depend upon sustained power. The terms “volatile-memory storage entity” and variants thereof, unless explicitly stated otherwise, describe a physical and/or logical unit of reference related to volatile memory storage resources. Examples of volatile-memory storage include inter-alia: random-access memory (RAM), dynamic random-access memory (DRAM), static random-access memory (SRAM), Extended Data Out DRAM (EDO DRAM), Fast Page Mode DRAM. Examples of a volatile-memory storage entity include inter-alia: dual in-line memory module (DIMM) including volatile memory integrated circuits of various types, small outline dual in-line memory module (SO-DIMM) including volatile memory integrated circuits of various types, MicroDIMM including volatile memory integrated circuits of various types, single in-line memory module (SIMM) including volatile memory integrated circuits of various types, and including collections of any of the above and various combinations thereof, integrated via a common circuit board, and/or integrated via any type of computer system including any type of server, such as a blade server, for example.

In the description of the present invention, reference is made to the term “non-volatile memory storage”. Unless explicitly stated otherwise, the terms “non-volatile memory storage” and variants thereof describe a component which includes one or more data retention modules that are capable of storing data thereon independent of sustained external power. The terms “non-volatile-memory storage entity” and variants thereof, unless explicitly stated otherwise, describe a physical and/or logical unit of reference related to non-volatile storage resources. Examples of non-volatile memory storage include inter-alia: magnetic media such as a hard disk drive (HDD), FLASH memory or FLASH drives, Electrically Erasable Programmable Read-Only Memory (EEPROM), battery backed DRAM or SRAM optical media such as CDR, DVD, and Blu-Ray Disk, and tapes. Examples of a non-volatile memory storage entity include inter-alia: Hard Disk Drive (HDD), Flash Drive, Solid-State Drive (SSD), and tapes.

In the description of the present invention, reference is made to the term “solid state storage”. The terms solid state storage and variants thereof, unless explicitly stated otherwise, refer to storage based on the semiconductor. The terms “solid state storage entity” and variants thereof, unless explicitly stated otherwise, describe a physical and/or logical unit of reference related to solid state storage resources. In the description of the present invention, reference is made to the term “non-solid state storage”. The terms “non-solid state storage” and variants thereof, unless explicitly stated otherwise, describe storage which is not based on the semiconductor. The terms “non-solid state storage entity” and variants thereof, unless explicitly stated otherwise, describe a physical and/or logical unit of reference related to non-solid state storage resources. Examples of solid state storage include, inter-alia, FLASH memory or FLASH drives, Electrically Erasable Programmable Read-Only Memory (EEPROM), battery backed DRAM or SRAM. Examples of non-solid-state storage include, include, inter-alia, magnetic storage media such as a hard disk drive (HDD), optical media such as CDR, DVD, and Blu-Ray Disk, and tapes.

In the description of the present invention, reference is made to the term “primary memory storage entity” and “backup memory storage entity”. The terms “primary memory storage entity” and variants thereof, unless explicitly stated otherwise, are used to describe a memory storage entity which is faster and more costly relative to a backup memory storage entity. Similarly, the terms “backup memory storage entity” and variants thereof, unless explicitly stage otherwise, are used to describe a memory storage entity which is slower and less costly relative to a primary storage entity.

In the description of the present invention, reference is made to the term “backing-up”. The terms backing-up”, and variants thereof, unless explicitly stated otherwise, are used to describe a process in which data is written to a backup memory storage entity which is a copy of, or enables recovery of, data that is at that point in time present in a primary memory storage entity.

In the description of the present invention, reference is made to the term “data relating to a command”. The terms “data relating to a command”, and variants thereof, unless explicitly stated otherwise, refer to any type of data relating to a command such as for example, an (original) data element which is the subject of the command, recovery enabling data, etc. Below, unless explicitly stated otherwise, the terms “data element” and variants thereof refer to an original data element which is the subject of a command. The terms “recovery-enabling data” and variants thereof, unless explicitly stated otherwise, describe certain supplemental data which, possibly in combination with reference to one or more data elements, (collectively) enable(s) recovery of a certain (other) data element.

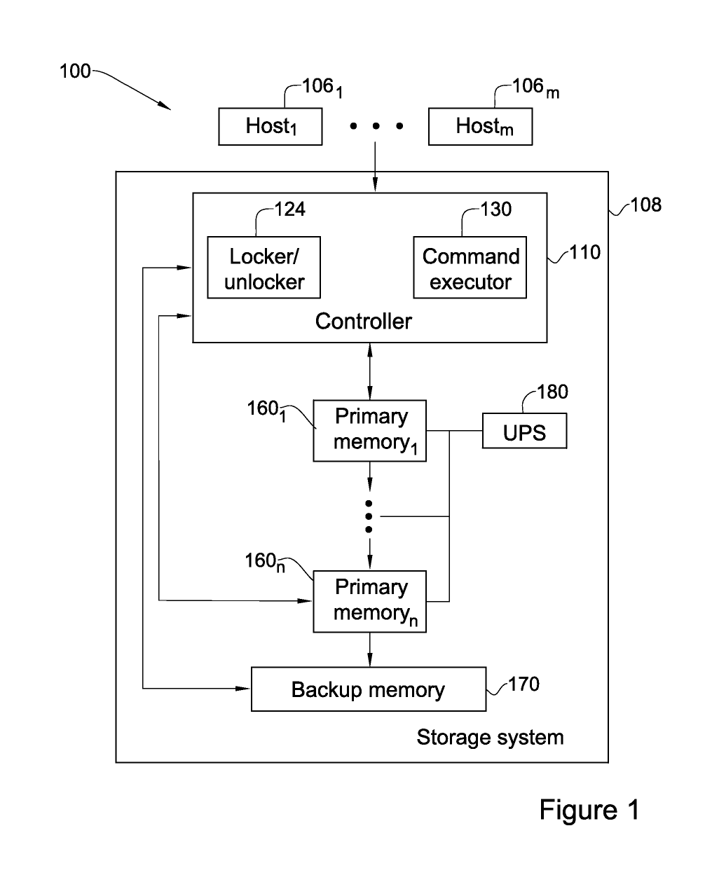

Referring now to the drawings, FIG. 1 is a high level block diagram of a system 100 for generating and managing write commands, according to some embodiments of the invention. In the illustrated embodiment, system 100 includes at least one host 106 and a storage system 108. For the sake of example, the illustrated embodiments of FIG. 1 show a plurality of hosts 106₁ to 106ₘ (where m≧2) but the invention is not so limited and in some embodiments there may be only one host 106. Host(s) 106 generate and transmit write commands to storage system 108. In the illustrated embodiments, storage system 108 includes at least one controller 110, at least one primary memory storage entity 160, at least one backup memory storage entity 170, and optionally at least one uninterruptible power supply (UPS) 180. For the sake of example, the illustrated embodiments of FIG. 1 show a plurality of primary memory storage entities 160₁ to 160ₙ (where n≧2), one backup memory storage entity 170, one controller 110 and optionally one UPS 180, but the invention is not so limited and in some embodiments there may be one primary memory storage entity 160, a plurality of backup memory storage entities 170, a plurality of controllers 110, and/or a plurality of UPS's or no UPS 180. Each module shown in FIG. 1 may be made up of any combination of software, hardware and/or firmware capable of performing the operations as defined and explained herein.

The modules in system 100 may be centralized in one location or dispersed over more than one location. In some embodiments, system 100 may comprise fewer, more, and/or different modules than those shown in FIG. 1. In some embodiments, the functionality of system 100 described herein may be divided differently among the modules of FIG. 1. In some embodiments, the functionality of system 100 described herein may be divided into fewer, more and/or different modules than shown in FIG. 1 and/or system 100 may include additional or less functionality than described herein. For example, in some cases system 100 may include additional modules unrelated to the generation and management of write commands.

The invention is not limited to a particular communication means or protocol for transferring generated write commands between host(s) 106 and storage system 108. Examples of possible transfer means include any known or future transfer means. Continuing with the examples, in various embodiments possible transfer means may be remote or local, wired or wireless, etc. One example of a possible protocol which may be used in the transfer is the SCSI protocol, but other embodiments may use other protocols. The invention is also not limited to a particular format for write commands. For example, in one embodiment a received write command may include the data to be written, whereas in other embodiments, the write command may not include the data to be written. In these latter embodiments, the data to be written may for example be retrieved by controller(s) 110, or for example, may be transferred to controller(s) 110 separately from the command.

In some embodiments, at least part of primary memory storage entity/ies 160 in storage system 108 is a volatile memory storage entity. Additionally or alternatively, in some embodiments at least part of backup memory storage entity/ies 170 in storage system 108 is a non-volatile memory storage entity.

Additionally or alternatively, in some embodiments, at least part of primary memory storage entity/ies 160 in storage system 108 is a solid state storage entity. Additionally or alternatively, in some embodiments at least part of backup memory storage entity/ies 170 in storage system 108 is a non-solid state storage entity.

In some embodiments where at least part of primary memory storage entity/ies 160 is a volatile memory storage entity, UPS unit(s) 180 may be configured to enable uninterruptible power to part or all of primary memory storage entity/ies 160 in storage system 108. Additionally or alternatively, in some embodiments, UPS unit(s) 180 may be configured to support one or more other elements in storage system 108, for example any of the following: the hardware of controller 110, the hardware operating part or all of backup memory storage entity/ies 170, etc

As illustrated in FIG. 1 controller(s) 110 include(s) command executor module(s) 130 and optionally locker/unlocker module(s) 124. The reader is referred to application PCT application number PCT/IL2010/000288 filed in Apr. 6, 2010 included in the appendix for more detail on optional locker/unlocker module 124. In some embodiments, controller(s) 110 may comprise fewer, more and/or different modules than illustrated in FIG. 1. In some embodiments, controller(s) 110 may include additional or less functionality than described herein. For example, in some cases controller(s) 110 may include additional functionality unrelated to managing write commands.

In some embodiments, there may be a single controller 110 carrying out the functions ascribed herein generally to controller 110 or more specifically to particular modules within controller 110. However, in some embodiments there may be a plurality of controllers 110 collectively carrying out the functions ascribed herein generally to controller 110 or more specifically to modules within controller 120. For example, in some of these embodiments, command executor module 130 may comprise one or more controllers 110 and/or locker/unlocker module 124 may comprise one or more other controllers 110. Continuing with the example, in one embodiment, command executor module 130 may comprise separate individual controllers or separate pluralities of controllers responsible for various command subsets (with each command subset including at least one command). In the same example, in another embodiment, command executor module 130 may alternatively comprise one controller or a plurality of controllers responsible for all commands, without particular assignment. In some cases with separate controllers or pluralities of controllers responsible for various commands, command executor module 130 may additionally comprise one or a plurality of controllers responsible for all commands, for instance for coordinating among the separate controllers or pluralities of controllers. Therefore, depending on the embodiment, command executor module 130 may comprise one or a plurality of controllers responsible for all commands, separate individual controllers or pluralities of controllers responsible for different commands, or a combination thereof. In embodiments where command executor module 130 includes separate individual controllers or separate pluralities of controllers responsible for different command subsets (in addition to or instead of controller(s) responsible for all commands), when reference is made below to action by command executor 130 involving a specific command, it should be understood to refer to the specific controller or controllers assigned to the subset which includes that command (in addition to or instead of controller(s) responsible for all commands), and not to controller(s) assigned to other subsets. In some embodiments with separate controllers or pluralities of controllers responsible for various command subsets, a particular controller may exist before command(s) in the command subset have been received and/or after command(s) in the command subset have been performed. In other embodiments, however, the particular controller may be dynamic, for example created when first a command for which the particular controller is responsible is received and then discarded when all commands for which the particular controller is responsible have been performed.

In another example, in some of these embodiments, additionally or alternatively, command executor 130 may comprise one or more controller(s) responsible for the various storage entities. Continuing with the example, in one embodiment, command executor 130 may comprise one controller for all storage entities, whereas in a second embodiment, command executor 130 may comprise separate individual controllers or separate pluralities of controllers responsible for various storage entities. Still continuing with the example, in some cases of the second embodiment there may be separate individual controllers or pluralities of controllers for primary memory storage entity/ies and backup memory storage entity/ies, whereas in other cases of the second embodiment there may be a separate individual controller or a separate plurality of controllers for each primary or backup memory storage entity.

For simplicity of description, unless explicitly stated otherwise, the single forms of host 106, primary memory storage entity 160, backup memory storage entity 170, UPS 180 and controller 110 are used below to denote both embodiments with one host 106, one primary memory storage entity 160, one backup memory storage entity 170, one UPS 180, and one controller 110 and embodiments with a plurality of any of hosts 106, primary memory storage entities 160, backup memory storage entities 170, UPS's 180 and/or controllers 110.

In some embodiments, the occupancy of primary memory in storage system 108 is limited to a maximum capacity. The maximum capacity may be limited due to the amount of available physical memory, cost considerations, power considerations, and/or any other considerations. The type of data in primary memory storage entity 160 which is considered when counting occupancy may vary depending on the embodiment. For example, in some of these embodiments, only data which still needs to be backed up to backup memory storage entity 170 is considered when counting occupancy and therefore the maximum capacity restricts the amount of data in primary memory storage entity 160 which still needs to be backed up. This example assumes that after the data which still needs to be backed up has been backed up, the storage segments in primary memory storage entity 160 which were occupied by the data become “vacant”, because the data is actively erased, denoted as erased, or may be overwritten. In this example the limitation on maximum capacity for non-backed up data (which needs to be backed up) may be due to the amount of available physical memory, cost considerations, power considerations, and/or any other considerations. In some cases of this example, assuming data which has already been backed up or does not need to be backed up is not considered when counting occupancy, the amount of physical memory in primary memory storage entity 160 is not necessarily constrained by the maximum capacity and may in some of these cases be larger than the maximum capacity. More generally, in some cases, primary memory storage entity 160 may include data which is not considered when counting occupancy, and therefore the amount of physical memory in primary memory storage entity 160 is not necessarily constrained by the maximum capacity and may in some of these cases be larger than the maximum capacity. In other examples, data which has already been backed up and/or data which does not need to be backed up is/are considered when counting occupancy.

The invention does not bind the amount of physical memory in primary memory storage entity 160. However to further enlighten the reader, some possible embodiments are now presented. In some embodiments, the amount of physical memory equals the maximum capacity. For example, if only data which still needs to be backed up to backup memory storage entity 170 is counted toward occupancy, then the amount of physical memory equals the maximum number of storage segments which can contain data that still need to be backed up. In some other embodiments, the amount of physical memory in primary memory storage entity 160 equals the amount of physical memory in backup memory storage entity 170. Other embodiments may involve other amounts of physical memory in primary memory storage entity 160.

In some of the embodiments where the maximum capacity restricts the amount of data in primary memory storage entity 160 which still needs to be backed up, it is assumed that at least part of primary memory storage entity 160 is a volatile memory storage entity. In these embodiments with volatile memory, the maximum capacity is limited at least partly due to power considerations. In these embodiments UPS 180 is configured to supply power to primary memory storage entity 160 for a limited time interval after a loss of external power (such as electricity) to storage system 108. Therefore, in these embodiments, primary memory storage entity 160 is supplied with power for this limited time interval after a loss of the external power. Assume that there is a predetermined rate for backing up data in primary memory storage entity 160 to backup memory storage entity 170. In these embodiments, in order to ensure no loss of data in the case of external power loss, the maximum capacity may in some cases be bound by the time interval in which UPS 180 can supply power after loss of external power multiplied by the back-up rate. The back-up rate is not limited by the invention, but in some embodiments may depend on the speed of backup memory storage entity 170, the pattern of writing to backup memory storage entity 170 (e.g. sequential versus random where random is typically although not necessarily slower), etc. For example, in one embodiment, the rate it takes to back up data may be calculated to equal (number of storage segments in data to be backed up)÷(worse case seek time+rotational latency time). Continuing with the example, in some cases the rate of writing to a storage entity may be calculated initially in accordance with one or more characteristics of the storage entity and then measured and adjusted as needed during the life of the storage entity. In certain embodiments, other rates discussed herein may be initially calculated and then measured and adjusted as necessary in a similar manner, where appropriate.

In some embodiments, storage system 108 may additionally or alternatively be constrained by limitations set by host 106. For example, in response to a write command issued by host 106, host 106 expects an acknowledgment from controller 110 for a successful write. In some embodiments of this example, host 106 sets a predetermined time interval to receive the acknowledgment, and if the acknowledgement is not received prior to the expiry of the set predetermined time interval, then a timeout is said to occur. If timeout occurs, host 106 will typically assume that the command was not successfully executed. Therefore, in these embodiments of this example controller 110 should attempt to acknowledge the command prior to timeout. In some cases, system 100 may include multiple hosts 106, each setting a time interval for commands thereof, which may or may not be the same as time intervals set for commands by other host(s) 106. Additionally or alternatively, in some cases system 100 may have different time intervals set for different commands originating from the same host 106. In such cases, and assuming controller 110 does not identify the actual time interval associated with the particular command being processed (for example does not identify the originating host 106 and/or distinguish among commands), the command should be acknowledged in these embodiments of this example prior to the expiry of the shortest possible time interval which could be set by any host 106 in system 100 for any command, in order to avoid timeout. If on the other hand, controller 110 does identify the actual time interval associated with the particular command, then in these embodiments of this example the command should be acknowledged prior to expiry of the actual time interval in order to avoid timeout.

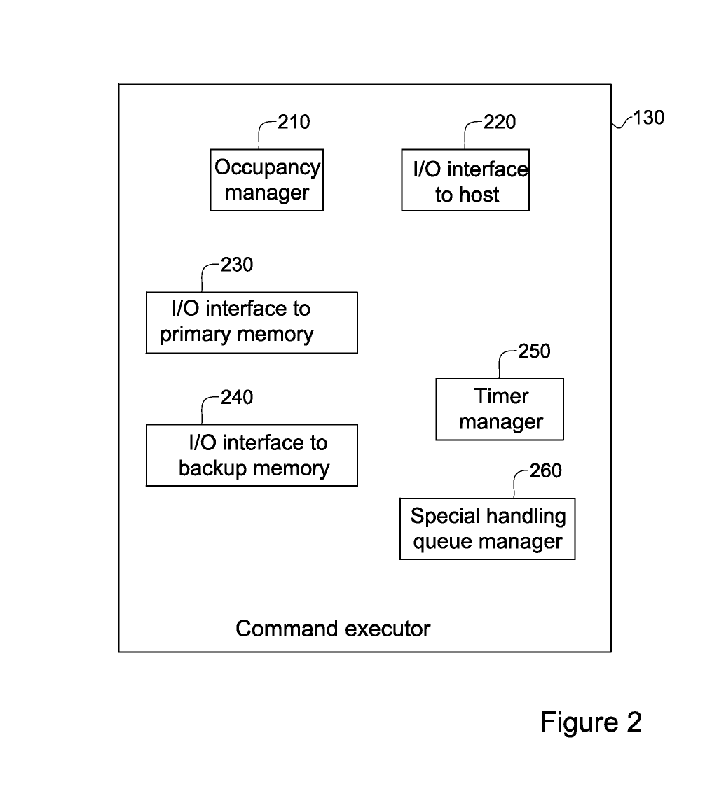

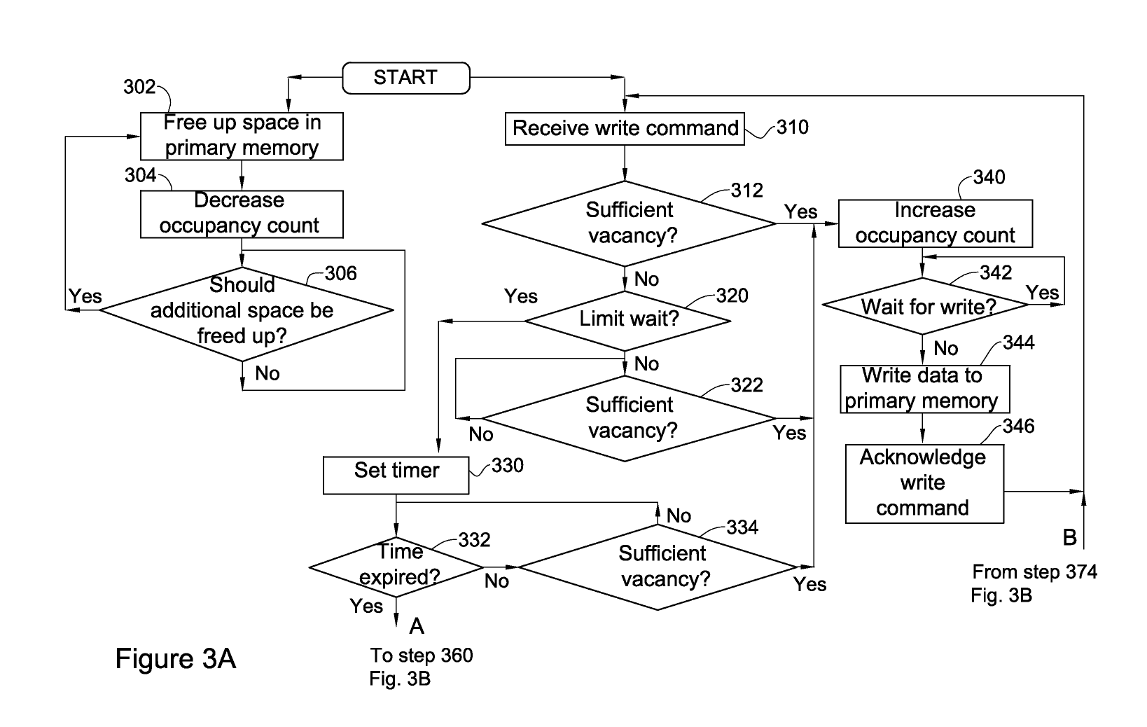

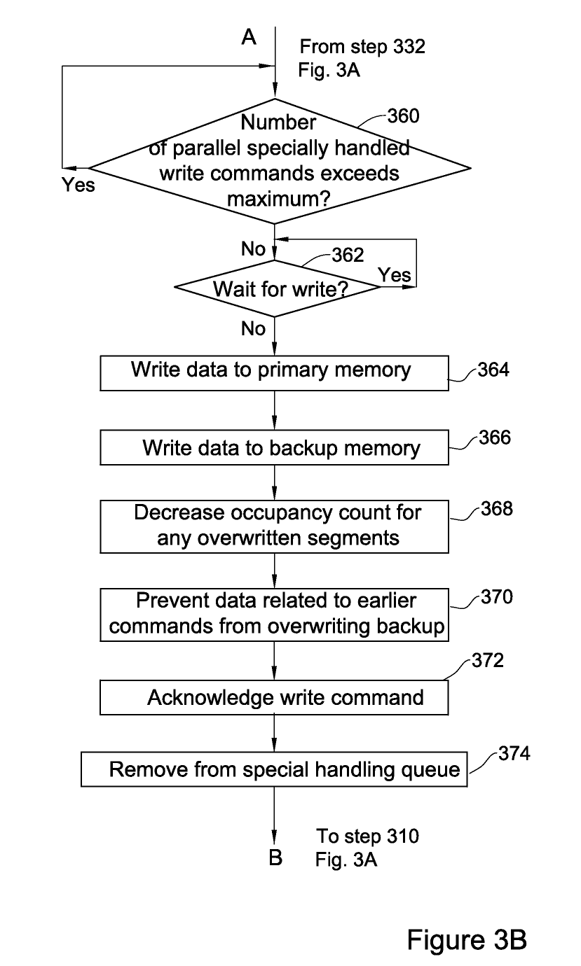

FIG. 2 is a block diagram of command executor 130, according to some embodiments of the invention. In the illustrated embodiments, command executor 130 includes an occupancy manager 210, an input/output (I/O) interface to host 220, an I/O interface to primary memory 230, an I/O interface to backup memory 240, a timer manager 250, and optionally a special handling queue manager 260. Each module shown in FIG. 2 may be made up of any combination of software, hardware and/or firmware capable of performing the operations as defined and explained herein. Some operations of modules shown in FIG. 2 are elaborated upon in the discussion of FIG. 3.

In the illustrated embodiments, occupancy manager 210 is configured to keep track of occupancy in primary memory storage entity 160. As mentioned above, the type of data in primary memory storage entity 160 which is considered when counting occupancy may vary depending on the embodiment. For example, in some cases occupancy manager 210 is configured to keep track of the number of storage segments in primary memory storage entity 160 whose content needs to be backed up in backup memory storage entity 170 but has not yet been backed up. Depending on the embodiment, any storage element(s) associated with managing the occupancy may be located in controller 110 (for example in memory that is located in manager 210) or may be located elsewhere in storage system 108 (for example in primary memory storage entity 160).

In the illustrated embodiments, I/O interface to host 220 is configured to communicate with host 106. For example, I/O interface to host 220 may receive a write command from host 106. As another example, I/O interface to host may additionally or alternatively be configured to send an acknowledgment to host 106 once the command has been successfully performed (where the timing of the acknowledgment will be described in more detail below with reference to FIG. 3)

In the illustrated embodiments, I/O interface to primary memory 230 is configured to communicate with primary memory storage entity 160. For example, I/O interface to primary memory 230 may be configured to write data relating to a command to primary memory storage entity 160. As another example, I/O interface to primary memory 230 is additionally or alternatively configured to receive an acknowledgment from primary memory storage entity 160 if and when the data has been successfully written. As another example, I/O interface to primary memory 230 may additionally or alternatively be configured to retrieve data from primary memory storage entity 160 for backup.

In the illustrated embodiments, I/O interface to backup memory 240 is configured to communicate with backup memory storage entity 170. For example, I/O interface to backup memory 240 is configured to write data relating to a command to backup memory storage entity 170. As another example, I/O interface to backup memory 240 may be additionally or alternatively configured to receive an acknowledgment from primary memory storage entity 170 if and when the data has been successfully written.

In the illustrated embodiments, timer manager 250 is configured to manage a timer. Depending on the embodiment, any storage element(s) associated with timer manager 250 may be located in controller 110 (for example in memory located in manager 250) or may be located elsewhere in storage system 108 (for example in primary memory storage entity 160).

In the illustrated embodiments, special handling queue manager 260 is configured to manage a queue for commands which require special handling. Depending on the embodiment, any storage element(s) associated with the management of the special handling queue may be located in controller 110 (for example in memory located in manager 260) or may be located elsewhere in storage system 108 (for example in primary memory storage entity 160). In some embodiments, special handling queue manager 260 may be omitted if there is no queue for commands which require special handling.

The modules in command executor 130 may be centralized in one location or dispersed over more than one location. In some embodiments, the functionality of command executor 130 described herein below may be divided into fewer, more and/or different modules than illustrated in FIG. 2. Additionally or alternatively, in some embodiments of the invention, command executor 130 may have more, less and/or different functionality than described herein, and/or the functionality described herein may be divided differently among the modules illustrated in FIG. 2. As an example of different modules, a function ascribed herein to command executor 130 may in some instances be performed by locker/unlocker 124 or vice versa. As an example of a larger number of modules, any of interfaces 220, 230, and/or 240 may in some cases be divided into a plurality of interfaces if there are multiple hosts 106, primary memory storage entities 160 and/or backup memory storage entities 170, respectively. As an example of functionality divided differently, functionality ascribed to a particular module in command executor 130 may be additionally or alternatively performed by one or more other modules in command executor 130. Continuing with the example, a function ascribed to any of occupancy manager 210, timer manager 250 or special handling queue manager 260 may be handled additionally or alternatively by one or more of the other non-ascribed modules 210, 250 and/or 260.

FIG. 3 is a flowchart illustration of a method 300 for managing write commands, according to some embodiments of the invention. In the illustrated embodiments, method 300 is performed by controller 110. In some cases, method 300 may include fewer, more and/or different stages than illustrated in FIG. 3, the stages may be executed in a different order than shown in FIG. 3, and/or stages that are illustrated as being executed sequentially may be executed in parallel.

In the illustrated embodiments of method 300, there are two processes which do not necessarily occur in parallel. The first process (stages 302 to 306) includes the reduction in occupancy count in primary memory storage entity 160 and the second process (remaining stages of method 300) includes the processing of a received write command.

In the illustrated embodiments, in stage 302 of the first process, controller 110 frees up space in primary memory storage entity 160, thus making storage segment(s) in primary memory storage entity 160 available to store new data.

For example in some embodiments, stage 302 may include controller 110, for instance I/O interface to primary memory 230 and/or I/O interface to backup memory 240, backing up data in primary memory storage entity 160 (which was considered when counting occupancy) to backup memory storage entity 170, thereby freeing up space in primary memory storage entity 160. The data may relate, for instance, to earlier received commands. Optionally, in some cases where stage 302 includes writing to backup memory storage entity 170, controller 110, for example locker/unlocker 124, obtains a lock on storage segments in backup memory storage entity 170, waiting if necessary, and/or later unlocks segment(s) in backup memory storage entity 170 if necessary, for example as described in the appendix. Optionally, in some cases where stage 302 includes writing to backup memory storage entity 170, controller 110, for example I/O interface to backup memory 240, may additionally or alternatively manage a queue of commands waiting to be written to (and/or of commands waiting to be read from) backup memory storage entity 170. Depending on the embodiment, the backing-up of data relating to a command to backup memory storage entity 170 may occur substantially immediately after data relating to a command has been written to primary memory storage entity 160 or may occur at any time after the data has been written to primary memory storage entity 160. In the illustrated embodiments, a write acknowledgement is returned to controller 110, for example to I/O interface to backup memory 240 after successful backing-up to backup memory storage entity 170. In some embodiments, the back-up proceeds at a rate which is not restricted by the invention but may in some cases depend on one or more factors such as the speed of backup memory storage entity 170, the pattern of writing to backup memory storage entity 170, etc, as described above.

In other examples, additionally or alternatively, space in primary memory storage entity 160 may be freed up by one or more other activities such as, erasing data which was considered when counting occupancy, un-protecting data which was considered when counting occupancy, etc.

In the illustrated embodiments in stage 304, controller 110, for example occupancy manager 210, reduces the count of the occupancy in primary memory storage 160 by the number of storage segments freed up in stage 302. For example, the count may be decreased by the number of storage segment(s) whose content has been backed up to backup memory storage entity 170, erased and/or unprotected, etc. In embodiments where the count of occupancy is decreased after backup of data has been performed, it is assumed that data in primary memory storage entity 160 may be overwritten after being backed up and therefore the count of occupancy in primary memory storage entity 160 is decreased (even if the data is not physically removed). In another example the freeing up of space and the reduction in the count of occupancy may be triggered by another activity such as erasing or un-protecting data which was considered when counting occupancy in addition to or instead of backup.

In the illustrated embodiments in stage 306 it is determined if additional space should be freed up in primary memory storage entity 160. If not (no to stage 306), for example because occupancy has gone down to zero or because freeing up of space is not currently desirable, then method 300 waits until additional space should be freed up. If and when additional space should be freed up (yes to stage 306), method 300 reiterates to stage 302.

In the illustrated embodiments, in stage 310 of the second process controller 110, for example I/O interface to host 220 receives a write command from host 106.

It is assumed that at least some data relating to the command that will be written, counts toward occupancy. Therefore in the illustrated embodiments in stage 312, controller 110, for example occupancy manager 210, determines if there is sufficient vacancy (e.g. enough available storage segments) in primary memory storage entity 160 to write data relating to the command. It is assumed that there is a maximum capacity, expressed for instance as a maximum number of storage segments which can store data that is considered when counting occupancy. For example, in some embodiments, there may be a maximum number of storage segments in primary memory storage entity 160 whose content needs to be backed up but has not yet been backed up to backup memory storage entity 170. Continuing with the example, in one embodiment where at least part of primary memory storage entity 160 includes a volatile memory storage entity, the maximum may equal the time interval in which UPS 180 can supply power after the loss of external power multiplied by the rate of back-up, expressed for instance as the number of storage segments backed up/unit time (see above discussion of backup rate). In some embodiments, occupancy manager 210 determines if there is sufficient vacancy by determining if the number of storage segments required to store data relating to the command which is to be considered when counting occupancy plus the number of storage segments already occupied in primary memory storage entity 160 by data which is considered when counting occupancy is less than or equal to the maximum capacity (e.g. maximum number of storage segments which can store data that is considered when counting occupancy). In some other embodiments, occupancy manager 210 determines if there is sufficient vacancy by determining if the number of storage segments required to store data relating to the command which is to be considered when counting occupancy, excluding segments whose data from any earlier commands is being overwritten, plus the number of storage segments already occupied in primary memory storage entity 160 by data which is considered when counting occupancy is less than or equal to the maximum capacity (e.g. maximum number of storage segments which can store data that is considered when counting occupancy). As an example of the latter embodiments, if a command relating to storage segments 1 to 10 will overwrite storage segments 5 to 7 from an earlier command then only segments 1 to 4 and 8 to 10 are storage segments required to store data relating to the command which are not overwriting data from any earlier commands.

If there is sufficient vacancy (yes to stage 312), then the command is handled in a usual manner beginning with stage 340. In the illustrated embodiments in stage 340, controller 110, for example occupancy manager 210, increases the count of occupancy by the number of storage segments in primary memory storage entity 160 required to store data relating to the command which counts toward occupancy, or increases the count by the number of storage segments in primary memory storage entity 160 required to store the data relating to the command which counts toward occupancy, excluding segments whose data from any earlier commands is being overwritten.

In the illustrated embodiments in stage 342, controller 110, determines whether or not the received command can be performed or needs to wait. If waiting is not required (no to stage 342) then method 300 proceeds to stage 344. If waiting is required (yes to stage 342), then method 300 waits until waiting is no longer required before proceeding to stage 344. For example, in one embodiment, locker/unlocker 124 performs stage 342 by obtaining a lock for the command on storage segment(s) in primary memory storage entity 160, waiting if necessary to obtain the lock, for instance as described in the appendix. As another example, additionally or alternatively, I/O interface to primary memory 230 may perform stage 342, waiting if necessary until any other command (or any other write command) in queue before the received command has been performed. In some embodiments, stage 342 may be omitted, for example if commands are only received after performance of previously received commands and/or if stage 342 is unnecessary for any other reason.

In the illustrated embodiments of stage 344, controller 110, for example I/O interface to primary memory 230, writes data relating to the command to primary memory storage entity 160 and receives an acknowledgement that the data was successfully written.

In the illustrated embodiments of stage 346, controller 110, for example I/O interface to host 220, transmits an acknowledgement to host 106 that the write command was successfully performed.

In some embodiments, after stage 344 or 346, controller 110, for example locker/unlocker 124, unlocks segment(s) in primary memory storage entity 160, if necessary, for example as described in the appendix. In some embodiments, additionally or alternatively after stage 344 or 346, controller 110, for example I/O interface to primary memory 230 removes the command from queue so that commands waiting in queue can be performed. In some embodiments, unlocking and/or removing from queue may be omitted, for example if host 106 only transmits another command after acknowledgement of the previously transmitted command, and/or because of any other appropriate reason.

Returning to the description of stage 312, there may instead not be sufficient vacancy (no to stage 312). It should be understood that in embodiments where stage 340 cannot directly follow stage 312 due to insufficient vacancy, extra time may in some cases be added to the process until the write acknowledgment of stage 346, compared to the case where stage 340 follows directly after a “yes” in stage 312. It should also be understood that any extra time added until acknowledgment may in some cases increase the likelihood of timeout by host 106 before the write acknowledgement can be returned.

If there is insufficient vacancy, then the illustrated embodiments of stage 320 controller 110 determines if a time limit should be set for waiting until there is sufficient vacancy in primary memory storage 160. For example, vacancy may become sufficient due to the execution of the first process of stages 302 to 306. For example, occupancy manager 210 may perform the determination.

In some embodiments, a time limit may never be set in stage 320 for waiting. In some other embodiments a time limit may always be set in stage 320 for waiting. In still other embodiments, a time limit may or may not be set in stage 320 for waiting. In some of these latter embodiments, a limit may or may not be set depending on the likelihood of a timeout occurring before completion of a time period for performing the activities of waiting until there is sufficient vacancy, writing data relating to said command to primary memory storage entity 160 and issuing a write acknowledgement. In various cases the likelihood may be influenced by any of the following characteristics: one or more characteristics of host 106, one or more characteristics of the received write command, one or more characteristics of primary memory storage entity 160, one or more characteristics of other commands being handled concurrently by controller 110 (if any), one or more characteristics of the data in primary memory storage entity 160, one or more characteristics which influence how long it would take for a command that is not specially handled to be written to primary memory storage entity 160, any other characteristic(s), or any combination of the above.

For example, in some embodiments, in stage 320 a limit is set for waiting if the received write command is large and is not set for waiting if the received write command is not large. Typically although not necessarily, it takes longer to free up a larger number of storage segments than a smaller number. These embodiments assume that the likelihood of timeout prior to write acknowledgement is higher when a larger number of storage segments needs to be freed up in primary memory (in the first process) rather than a smaller number, in order for there to be sufficient vacancy to accommodate the write command. Therefore, these embodiments assume that for a command that is not specially handled, it would take longer to write the command to primary memory storage entity 160 if the command is a large command rather than a small command.

These embodiments do not constrain the definition of large, and a command which is considered large in one embodiment may not necessarily be considered large in another embodiment. In various embodiments, the minimum size of a command for the command to be considered large may be static or dynamic during the lifetime of system 100. As an example of the latter embodiment, assume time intervals for receiving an acknowledgement before timeout vary depending on the originating host 106 and/or command and that controller 110 can identify the actual time interval associated with the received command as discussed above. In this case, if the minimum size of a command for the command to be considered large is at least partly dependent on the length of the time interval, the minimum size will be dynamic. As another example of the latter embodiment, assume that the minimum size of a command for the command to be considered large is additionally or alternatively at least partly dependent on vacancy level in primary memory storage entity 160. In this example, as vacancy level varies, the minimum size may also vary (assuming no other variables cancel out the variation in vacancy).

Although as stated above, the minimum size of a command for the command to be considered large is not limited by the invention, for further enlightenment to the reader a few examples are now presented. In one embodiment, any command which requires writing to at least a predetermined number of storage segments in primary memory storage 160 is considered large, where the predetermined number is at least partly dependent on the time interval set by the host 106 before timeout. For simplicity of explanation, this predetermined number is called hereinbelow “time-out related predetermined number”. In another embodiment, any command which requires writing to at least a certain number of storage segments in primary memory storage 160 is considered large, where the certain number equals the time-out related predetermined number plus the vacancy level (e.g. number of remaining storage segments for storing data which is considered when counting occupancy) in primary memory storage entity 160. In another embodiment, any command which requires writing to at least a certain number of storage segments in primary memory storage 160 is considered large, where the certain number equals the time-out related predetermined number plus the vacancy level (e.g. number of vacant storage segments for storing data which is considered when counting occupancy) in primary memory storage entity 160 plus the amount of overlapping data (e.g. the number of storage segments required to store the data relating to the command, which are overwriting data from any earlier commands).

In some cases, the time-out predetermined number is set based on a tradeoff between timeout and disk performance considerations. If the predetermined number is set too low then the disk performance may be poor, because special handling may cause extra disk seeks relative to usual handling. For example, in some cases, each command which is handled specially moves the head of the disk to a new position which might then require an additional seek to get back to the position where the head was before the special handling. If the predetermined number is set too high then the risk of timeout may also be too high.

In some embodiments, the time-out predetermined number may be adapted for changing conditions. For example, if a timeout occurred, then the time-out predetermined number may be reduced in order to prevent a timeout from re-occurring. As another example, if it is seen that there are too many commands not specially handled, resulting in a long wait which risks timeout, then the time-out predetermined number may be reduced in order to cause more commands to be specially handled.

As another example, in some embodiments, additionally or alternatively, a limit is set or not set for waiting depending on the location in backup memory storage entity 170 that the freed up storage segments are backed up to, for example during stage 302. These embodiments assume that the likelihood of timeout prior to write acknowledgement is higher if the freed up storage segments are backed up to certain locations in backup memory storage 170. Therefore, these embodiments assume that for a command that is not specially handled, it would take longer for the command to be written to primary memory storage entity 160 if the backup of freed up storage segments are to certain locations in backup memory storage entity 170 rather than to other locations.

As another example, in some embodiments, additionally or alternatively, a limit is set for waiting if the average number of segments per command stored in primary memory storage entity 160 is at or smaller than a predetermined ceiling and not set if the average is larger than a predetermined ceiling. Typically although not necessarily, it takes longer to free up space containing a large number of small commands due to the higher number of disk seeks than the same space containing a smaller number of large commands. These embodiments assume that the likelihood of timeout prior to write acknowledgement is higher when the average number of segments per command is at or smaller than a predetermined ceiling. Therefore, these embodiments assume that for a command that is not specially handled, it would take longer for the command to be written to primary memory storage entity 160 if the space that will be freed up in primary memory storage entity 160 (e.g. during stage 302) includes more commands whose average number of segments is smaller than if the space that will be freed up includes less commands whose average number of segments is larger.

As another example, in some embodiments, additionally or alternatively, a limit is set for waiting when the percentage of data occupying non-sequential storage segments (rather than sequential storage segments) in primary memory storage entity 160 is at or above a predetermined percentage and not set if the percentage of data elements occupying non-sequential storage segments (rather than sequential storage segments) is below a predetermined percentage. Typically although not necessarily, it takes longer to free up non-sequential storage segments than sequential storage segments. These embodiments assume that the likelihood of timeout prior to write acknowledgement is higher when the data to be freed up (e.g. during stage 302) is non-sequential than when the data is sequential. Therefore, these embodiments assume that for a command that is not specially handled, it would take longer for the command to be written to primary memory storage entity 160 if the percentage of data occupying non-sequential storage segments in primary storage entity 160 is higher than if the percentage were lower.

As another example, a limit may be set for waiting in some cases if any one of a group of conditions is fulfilled. Continuing with the example, in some of these cases a limit may be set if the command is large, the percentage of data occupying non-sequential storage segments in primary memory storage entity 160 is at or above a predetermined percentage, the average number of segments per command in primary memory storage entity 160 is at or smaller than a predetermined ceiling, or when freed up storage segments are to backed up to certain locations in backup memory storage entity 170. In these cases of the example a limit is not set for waiting if the command is not large, the percentage of data occupying non-sequential storage segments is below the predetermined percentage, the average number of segments per command in primary memory storage entity 160 is larger than a predetermined ceiling, and the freed up storage segments are to be backed up to other locations in backup memory storage entity 170.

In the illustrated embodiments, if the wait is not to be limited, (no to stage 320), then in stage 322 controller 110, for example occupancy manager 210, waits until there is sufficient vacancy in primary memory storage entity 160 (e.g. enough available storage segments) to write the data relating to the command. It is assumed that due to the execution of the first process of freeing up space, described above with reference to stages 302 to 306, there will eventually be sufficient vacancy. Until there is sufficient vacancy (no to stage 322) method 300 waits at stage 322. If and when there is sufficient vacancy, method 300 continues to stage 340 as described above.

As mentioned above, it is assumed that there is a maximum capacity, expressed for instance as a maximum number of storage segments which can store data that is considered when counting occupancy. For example, in some embodiments, there may be a maximum number of storage segments in primary memory storage entity 160 whose content needs to be backed up but has not yet been backed up to backup memory storage entity 170. Continuing with the example, in one embodiment the maximum may equal the time interval in which UPS 180 can supply power after the loss of external power multiplied by the rate of back-up, expressed for instance as the number of storage segments backed up/unit time (see above discussion of back-up rate). In some embodiments, occupancy manager 210 determines if there is sufficient vacancy by determining if the number of storage segments required to store the data relating to the command which is considered when counting occupancy plus the number of storage segments already occupied in primary memory storage entity 160 by data which is considered when counting occupancy is less than or equal to the maximum capacity (e.g. maximum number of storage segments which can store data that is considered when counting occupancy). In some other embodiments, occupancy manager 210 determines if there is sufficient vacancy by determining if the number of storage segments required to store the data relating to the command which is considered when counting occupancy, excluding segments whose data from any earlier commands is being overwritten, plus the number of storage segments already occupied in primary memory storage entity 160 by data which is considered when counting occupancy is less than or equal to the maximum capacity (e.g. maximum number of storage segments which can store data that is considered when counting occupancy.)

Returning to the description of stage 320, if instead the wait is limited (yes to stage 320), then in the illustrated embodiments of stage 330, controller 110, for example timer manager 250, sets a timer. Depending on the embodiment, the time set on the timer may always be the same for system 100, or may not necessarily always be the same for system 100. For example, in some embodiments the time set on the timer is much smaller than the time interval set by host 106 for write acknowledgement prior to timeout so that once the time on the timer expires there will still be sufficient time to specially handle the command by writing to backup memory storage entity 170 and returning an acknowledgement to host 106 before the time interval set by host 106 ends. As mentioned above, depending on the embodiment, the time interval or shortest time interval may not vary during the life of system 100, or time intervals for receiving an acknowledgement before timeout may vary depending on the originating host 106 and/or command (with controller 110 identifying the actual time interval associated with the received command as discussed above).

In various embodiments, the time set on the timer may depend on one or more possibly varying factors. Examples of factors, include inter-alia: rate for backing up data in primary memory storage entity 160 to backup memory storage entity 170 (as discussed above), the time interval set by host 106 for write acknowledgement prior to timeout, the size of the command, the rate of special handling of stages 360 to 374, the number (zero or above) of other command(s) or other write command(s) previously received and not yet performed, the amount of overlapping data, rate of writing to primary memory, any other factors, or any combination of any of the above. For example, in some embodiments, the time may be initially set to equal the number of segments in the command divided by the rate per segment for backing up data in primary memory storage entity 160 to backup memory storage entity 170. As another example, in some other embodiments, the time on the timer may be initially set to be longer if the number of other command(s) or other write command(s) previously received and not yet performed is larger because it is assumed there is more time until the turn of the current command to be executed. Continuing with the example, in some of these embodiments, the time may be initially set to equal or be less than the number of segments in the command (X) divided by the rate (R) per segment for backing up data in primary memory storage entity 160 to backup memory storage entity 170 (described above) plus the number of segments of other command(s) or other write command(s) (X′) previously received and not yet performed, divided by the rate of writing to primary memory and backup memory (R′). Thus the timer will be set to T=(X/R)+(X′/R′). In some embodiments one may set R′ to equal R. In these examples, overlapping data may in some cases be taken into account by reducing the number of segments in the command by the number of segments of overlapping data.

In some embodiments, the set time on the timer should be less than the time interval set by host 106 for write acknowledgement prior to timeout T₀. Additionally or alternatively, in some embodiments the set time on the timer T plus the time T″ it takes for special handling (e.g. equal to or less than the number of segments in the command X divided by the backup rate of the special handling R″) should be less than the time interval set by host 106 for write acknowledgement prior to timeout. T₀>T+T″ where T″<=X/R″ These embodiments attempt to ensure that special handling after the time expired would not result in a timeout. Additionally or alternatively, in some embodiments it may be checked that the initial time or the initial time plus the time for special handling is less than a function of the time interval set by host 106 for write acknowledgement prior to timeout. The function of the time interval can be any function, for example one which results in a lower number than the actual time interval.

In some embodiments, the time set on the timer may be adapted for changing conditions. For example, if a timeout occurs, the time set on the timer may be reduced. As another example, if no timeout occurred, the time set on the timer may be increased.

In the illustrated embodiments, in stage 332, controller 110, for example timer manager 250, keeps track of whether or not the time set on the timer has expired. As long as the time has not expired, controller 110, for example occupancy manager 210, keeps track of whether or not there is sufficient vacancy in primary memory storage entity 160 (e.g. enough available storage segments) to write the data relating to the received command. Due to the execution of the first process of freeing up space, described above with reference to stages 302 to 306, space is being freed up but enough space may or may not be freed up before the timer expires. If enough space has been freed up so that there is sufficient vacancy prior to the expiry of the timer (yes to stage 334) then method 300 continues to stage 340 as described above.

As mentioned above, it is assumed that there is a maximum capacity, expressed for instance as a maximum number of storage segments which can store data that is considered when counting occupancy. For example, in some embodiments, there may be a maximum number of storage segments in primary memory storage entity 160 whose content needs to be backed up but has not yet been backed up to backup memory storage entity 170. Continuing with the example, in one embodiment the maximum may equal the time interval in which UPS 180 can supply power after the loss of external power multiplied by the rate of back-up, expressed for instance as the number of storage segments backed up/unit time (see above discussion of back-up rate). In some embodiments, occupancy manager 210 determines if there is sufficient vacancy by determining if the number of storage segments required to store the data relating to the command which is considered when counting occupancy plus the number of storage segments already occupied in primary memory storage entity 160 by data which is considered when counting occupancy is less than or equal to the maximum capacity (e.g. maximum number of storage segments which can store data that is considered when counting occupancy). In some other embodiments, occupancy manager 210 determines if there is sufficient vacancy by determining if the number of storage segments required to store the data relating to the command which is considered when counting occupancy, excluding segments whose data from any earlier commands is being overwritten, plus the number of storage segments already occupied in primary memory storage entity 160 by data which is considered when counting occupancy is less than or equal to the maximum capacity (e.g. maximum number of storage segments which can store data that is considered when counting occupancy).

The illustrated embodiments of the second process so far described include usual handling of the command where acknowledgement of the write command in stage 346 occurs after writing to primary memory storage entity 160.

In one implementation of these embodiments, in operation, when a write command is issued by host 106, a data element which is the subject of the command is stored on first primary memory storage entity 160₁. In addition, the data element and/or recovery enabling data corresponding to the data element is stored on a second primary memory storage entity 160₂. Once the data is stored on second primary memory storage entity 160₂, a write acknowledgement is returned to the issuing host 106. At any time after the write acknowledgement is returned to host 106, a controller associated with second primary memory storage entity 160₂, for example controller 110, issues a write command, causing a copy of the data element and/or recovery enabling data on the second primary memory storage entity 160₂ to be stored on backup memory storage entity 170.

In some cases of this implementation, the controller associated with second primary memory storage entity 160₂ issues the write command substantially immediately upon storage of the recovery enabling data on second primary memory storage entity 160₂. However, in other cases of this implementation, the write command may be delayed, for example to allow completion of a priority operation or a priority sequence that is concurrently pending or that is concurrently taking place within the system. In one of these embodiments, a limited duration delay is allowed whereas in another embodiment the allowed duration delay is unlimited.

Depending on the embodiment of this implementation, a write acknowledgment may or may not be returned after a copy of the data element and/or recovery enabling data is stored on backup memory storage entity 170. Also depending on the embodiment, removal (for example by deletion, copying over, etc) of the data element and/or recovery enabling data on the second primary memory storage entity 160₂ and/or removal of the data element from first primary memory storage entity 160₁ may or may not be allowed after a copy has been stored on backup memory storage entity 170.

In some cases in this implementation, where data which needs to be backed up but has not yet been backed up is considered when counting occupancy, the occupancy of second primary memory storage entity 160₂ is considered when determining if there is sufficient vacancy (rather than the occupancy of first primary memory storage entity 160₁), because data from second primary memory storage entity 160₂ is backed up rather than data from first primary memory storage entity 160₁. Similarly, in an implementation where data which needs to be backed up but has not yet been backed up is considered when counting occupancy, and where data relating to a command flows through multiple levels of primary memory, for example up until the n^{th} primary memory storage entity 160ₙ and is then backed up from n^{th} primary memory storage entity 160ₙ to backup memory storage entity 170, the occupancy of n^{th} primary memory storage entity 160ₙ is considered when determining if there is sufficient vacancy. In another implementation with multiple levels of primary memory (n≧2), backup may occur from one or more of the lower levels of primary memory (i.e. from level 1 . . . n−1) in addition to or instead of from the n^{th} level. In this implementation, the occupancy of the lower level(s) may additionally or alternatively be considered when determining if there is sufficient vacancy.

Returning to the description of stage 332, in the illustrated embodiments if the time expired before there is sufficient vacancy (yes to stage 332) then the maximum capacity limit is disregarded and the command is instead specially handled beginning in stage 360.

In the illustrated embodiments in stage 360, controller 110, for example special handling queue manager 260, determines if the number of specially handled write commands being handled in parallel in storage system 108 exceeds a predetermined maximum. For example, in some cases there may be a maximum number of commands that can be specially handled in parallel due to system constraints. System constraints may include for example, the desire not to starve the copying of data from primary memory storage entity 160. If the number of specially handled commands does not exceed the maximum (no to stage 360) then method 300 proceeds to stage 362. If the number of specially handled write commands exceeds the maximum (yes to stage 360), then controller 110, for example special handling queue manager 260, puts the received command in queue and increments the number of specially handled commands waiting in queue. Controller 110, for example special handling queue manager 260, keeps the received command in queue until the number of specially handled write commands does not exceed the maximum. When the number of specially handled write commands does not exceed the maximum (no to stage 360), method 300 continues with stage 362. If there is no maximum to the number of specially handled write commands that can be handled in parallel, then stage 360 can be omitted and method 300 proceeds directly to stage 362 after a “yes” in stage 332.

In the illustrated embodiments in stage 362, controller 110 determines whether or not the specially handled command can be performed or needs to wait. If waiting is not required (no to stage 362) then method 300 proceeds to stage 364. If waiting is required (yes to stage 362), then method 300 waits until waiting is no longer required before proceeding to stage 344. For example, in one embodiment, locker/unlocker 124 performs stage 362 by obtaining a lock for the command on storage segment(s) in primary memory storage entity 160 and/or backup memory storage entity 170, waiting if necessary to obtain the lock, for instance as described in the appendix. As another example, additionally or alternatively, I/O interface to primary memory 230 and/or I/O interface to backup memory 240 may perform stage 362, waiting if necessary until any other earlier received specially handled write command has been performed.

As will be described below, depending on the embodiment of the special handing, writing may occur only to backup memory storage entity 170 or to both primary memory storage entity and backup memory storage entity 170. In some embodiments with locking of storage segments and where writing occurs to both primary memory storage entity 160 and backup memory storage entity 170, segments in primary memory storage entity 160 and in backup memory storage entity 170 are independently locked. (If writing only occurs to backup memory storage entity, then backup memory storage entity 170 is necessarily independently locked). In some other embodiments where writing occurs to both primary memory storage entity 160 and backup memory storage entity 170, there is a tight coupling between storage segments in primary memory storage entity 160 and in backup memory storage entity 170. This coupling, for example, may dictate that a command will always operate first on segments in primary memory storage entity 160 and only then on segments in backup memory storage entity 170. In some of these embodiments coinciding with this example, therefore, as long as segments in primary memory storage entity 160 are locked, the segments in backup memory storage entity 170 are effectively locked and do not need to be independently locked.

In the illustrated embodiments of optional stage 364, controller 110, for example I/O interface to primary memory 230, writes data relating to the command to primary memory storage entity 160 and receives an acknowledgement that the data was successfully written. In some embodiments, stage 364 may be omitted.

In the illustrated embodiments of stage 366, controller 110, for example I/O interface to backup memory 240 writes data relating to the command to backup memory storage entity 170 and receives an acknowledgement that the data was successfully written.

In the illustrated embodiments of optional stage 368, controller 110, for example, occupancy manager 210, decreases the count of occupancy in primary memory storage 160 by the number of storage segments relating to earlier commands which were overwritten in stage 364 (or would have been overwritten if stage 364 had been executed). For example, if segments 5 to 7 in primary memory storage 160 relating to one or more earlier commands were overwritten by the specially handled command (or would have been overwritten if stage 364 had been executed) and therefore no longer need to be backed up to backup memory 170, controller 110 can decrease the count of occupancy by three segments (corresponding to segments 5 to 7). In some embodiments, stage 368 may be omitted, for example if no overwriting occurred or would have occurred, or for example, if such accuracy in the count is not required.

In the illustrated embodiments of optional stage 370, any data relating to previously received commands in primary memory storage entity 160, which is slated to be backed up to any storage segment in backup memory storage entity 170 now occupied by data relating to the current command, is prevented from being backed up. For example, in various embodiments the data may be erased from primary memory storage entity 160, or denoted as such for instance by removing an indication that the data is supposed to be backed up, etc. In some embodiments, stage 370 may be omitted, for example if there is no data in primary memory storage entity 160 relating to earlier commands which could overwrite the data relating to the current command in backup memory storage entity 170.

In the illustrated embodiments of stage 372, controller 110, for example I/O interface to host 220, transmits an acknowledgement to host 106 that the write command was successfully performed.

In the illustrated embodiments of optional stage 374, controller 110, for example special handling queue manager 260, removes the command from the special handling queue and decrements the number of specially handled commands waiting in queue, thereby possibly allowing other waiting specially handled commands to be performed. Additionally or alternatively, in some embodiments controller 110, for example locker/unlocker 124, may optionally unlock segment(s) in primary memory storage entity 160 and/or backup memory storage entity 170 (independently or effectively), if necessary, for example as described in the appendix. In some embodiments, stage 374 may be omitted, for example if there is no maximum to the number of specially handled write commands that can be handled in parallel and/or no lock.

In one implementation where there are two or more primary memory storage entities 160, in operation, when a command is specially handled, a data element which is the subject of the command is stored on a first primary memory storage entity 160₁. Then a controller associated with the first primary memory storage entity 160₁, for example controller 110, issues a write command, causing the data element and/or recovery enabling data to be stored on backup memory storage entity 170, omitting storage on any other primary memory storage entities 160.

In some embodiments of this implementation, the specially handled command may occupy storage segments in backup memory storage entity 170 to which second primary memory storage entity 160₂, or higher level primary memory storage entity/ies may wish to write data which is associated with command(s) received earlier. In these embodiments, it may be important to ensure that data in second primary memory storage entity 160₂, and/or in higher level primary memory storage entity/ies is not mistakenly copied to any storage segments in backup memory 170 written to in stage 366, thus erasing the data written in stage 366. Therefore, data which second primary memory storage entity 160₂, or higher level primary memory storage entity/ies wishes to write to any of the storage segments written to in stage 366 is prevented from being backed up from second primary memory storage entity 160₂, and/or from higher level primary memory storage entity/ies, for example by erasing the data and/or for example by removing an indication that the data is supposed to be backed up.

In another implementation of command special handling, the data element and/or recovery enabling data may be backed up directly to backup memory storage entity 170, skipping storage entirely on any primary memory storage entity 160. In some embodiments of this implementation, the specially handled command may occupy storage segments in backup memory storage entity 170 to which any primary memory storage entity 160 may wish to write data which is associated with command(s) received earlier. In these embodiments, it may be important to ensure that data in any primary memory storage entity 160 is not mistakenly copied to any storage segments in backup memory 170 written to in stage 366, thus erasing the data written in stage 366. Therefore, the data which any primary memory storage entity 160 wishes to write to any of the storage segments written to in stage 366 is prevented from being backed up from primary memory storage entity 160, for example by erasing the data and/or for example by removing an indication that the data is supposed to be backed up.

It is noted that in the illustrated embodiments where it is assumed that the wait was limited justifiably in stage 330, the time it takes for the timer to expire plus the time it takes to execute special handling until acknowledgement should preferably not be more than the time it would have taken to wait for sufficient vacancy and to execute stages 340 to 346. Therefore assuming the wait was limited justifiably, the likelihood of timeout occurring prior to write acknowledgment is typically although not necessarily lessened due to the special handling of the command.

It is also noted that assuming that only data in primary memory storage entity 160 which needs to be backed up but has not yet been backed up counts toward occupancy, the optional writing to the primary memory storage entity 160 in stage 364 does not increase the count of occupancy of primary memory storage entity 160. Data relating to the command is also written to backup memory storage entity 170 prior to acknowledging the write command. Therefore after acknowledgment of the write command, the data written to primary memory storage entity 160 is not essential, does not need to be backed up, and may be erased or overwritten if desired. The occupancy count of backup memory storage entity 160 is thus not increased by the special handing.

In the illustrated embodiments, the second process of method 300 repeats for each received write command, beginning with stage 310 after stage 372 or 374 has been executed.

According to the present invention, there is further provided at least one computer readable medium having a computer readable code embodied therein for managing write commands in a storage system, the computer readable code comprising instructions for: receiving a write command; determining whether or not primary memory has sufficient vacancy to write data relating to said command; if said primary memory does not have sufficient vacancy, then determining whether or not to limit waiting for vacancy to become sufficient; and if determined to limit waiting and if said limit has been exceeded then after said limit has been exceeded: (a) writing data relating to said command to backup memory; and (b) acknowledging success for said write command after said data has been written to said backup memory.

It will be clear to a person who is clear in the art that further variations and implementations of method 300, e.g. such as those exemplified above, may also be implemented as further instructions of the computer readable code. The computer readable code may be stored on one or more computer readable mediums (e.g. multiple hard disk drives), and may be read and executed by one or more processors.

It will also be understood that in some embodiments the system or part of the system according to the invention may be a suitably programmed computer. Likewise, some embodiments of the invention contemplate a computer program being readable by a computer for executing a method of the invention. Some embodiments of the invention further contemplate a machine-readable memory tangibly embodying a program of instructions executable by the machine for executing a method of the invention.

While certain features of the invention have been illustrated and described herein, many modifications, substitutions, changes, and equivalents will occur to those skilled in the art. It is therefore to be understood that the appended claims are intended to cover all such modifications and changes as fall within the true scope of the invention.

What is claimed is:

1. A method of managing write commands in a storage system, comprising:
receiving a write command;
determining whether or not primary memory has sufficient vacancy to write data relating to said command;
if said primary memory does not have sufficient vacancy, then determining whether or not to limit waiting for vacancy to become sufficient; and
if determined to limit waiting and if said limit has been exceeded then after said limit has been exceeded:
writing data relating to said command to backup memory; and
acknowledging success for said write command after said data has been written to said backup memory.

2. The method of claim 1, wherein if determined to limit waiting and if said wait has been exceeded, then further comprising, after said wait has been exceeded, writing data relating to said command to said primary memory.

3. The method of claim 2, further comprising:
not increasing a count of occupancy by a number of storage segments occupied by said data written to said primary memory.

4. The method of claim 2, further comprising:
reducing a count of occupancy by a number of storage segments relating to previous commands overwritten by said data written to said primary memory.

5. The method of claim 1, wherein if determined to limit waiting and if said limit has been exceeded then after said limit has been exceeded further comprising:
if said primary memory includes data relating to a previously received command which is slated to be backed up to a storage segment in said backup memory occupied by data relating to said received command, then preventing said data in primary memory from being backed up to said backup memory.

6. The method of claim 1, wherein if determined to limit waiting and if said limit has been exceeded then after said limit has been exceeded further comprising:
if there are too many commands whose limit has been exceeded and whose related data needs to be written to said backup memory, then waiting until there are no longer too many commands before performing said writing.

7. The method of claim 1, wherein said determining whether or not said primary memory has sufficient vacancy, includes:
calculating whether or not a sum of a number of storage segments in said primary memory whose content has not been backed up to backup memory and a number of storage segments required to write data relating to said command which needs to be backed up exceeds a predetermined maximum capacity.

8. The method of claim 1, wherein said determining whether or not said primary memory has sufficient vacancy, includes:
calculating whether or not a sum of a number of storage segments in said primary memory whose content has not been backed up to backup memory and a number of storage segments required to write said data relating to said command which needs to be backed up excluding segments whose data from any earlier commands is being overwritten exceeds a predetermined maximum capacity.

9. The method of claim 8, wherein said primary memory includes volatile memory and said predetermined maximum capacity is at least partly dependent on a limited time interval value during which said primary memory is supplied with power after cessation of external power.

10. The method of claim 8, wherein said predetermined maximum capacity is less than the amount of physical memory in said primary memory.

11. The method of claim 8, wherein said predetermined maximum capacity equals amount of physical memory in said primary memory.

12. The method of claim 1, further comprising:
if said primary memory has sufficient vacancy when said command is received, afterward if waiting was not limited, or afterward but before a time limit has been exceeded if waiting was limited, then:
writing data relating to said command to said primary memory; and
acknowledging success for said write command before backing up data relating to said command in said backup memory.

13. The method of claim 1, wherein said determining whether or not to limit waiting includes:
determining a likelihood that a time period for waiting until there is sufficient vacancy, writing data relating to said command, and acknowledging said write command will exceed a timeout allowed for said storage system;
if said likelihood is above a predetermined threshold, then determining to limit waiting; and
else if said likelihood is below a predetermined threshold, then determining not to limit waiting.

14. The method of claim 1, wherein if determined to limit waiting and if said wait has been exceeded, then after said wait has been exceeded further comprising:
causing storage segments slated to store data relating to said command to be locked in said backup memory prior to said writing.

15. The method of claim 14, wherein said causing includes:
locking storage segments in said primary memory, thereby effectively locking said storage segments in said backup memory.

16. The method of claim 14, wherein said causing includes:
independently locking storage segments in said backup memory.

17. The method of claim 1, wherein said limit is at least partly dependent on a timeout allowed for said storage system.

18. A method of managing write commands in a storage system, comprising:
receiving a write command;
determining that primary memory does not currently have sufficient vacancy to write data relating to said received write command;
determining that a likelihood of a time period exceeding a timeout allowed for said storage system, is greater than a predetermined threshold, wherein said time period includes time for waiting until there is sufficient vacancy, writing data relating to said command, and acknowledging said write command;
prioritizing performance of said write command by limiting time that said write command waits for vacancy in said primary memory to become sufficient; and
after said limit has expired, writing data relating to said command to backup memory, and acknowledging said write command.

19. The method of claim 18, wherein if a number of write commands with prioritized performance exceeds a maximum, then said related data is written to backup memory only after said limit has expired and said number of write commands with prioritized performance has fallen below said maximum.

20. A system for managing a write command, comprising:
a host interface for receiving a write command;
an occupancy manager for determining whether or not primary memory has sufficient vacancy to write data relating to said command, and if said primary memory does not have sufficient vacancy, then for determining whether or not to limit waiting for vacancy to become sufficient;
a timer manager for determining if said limit has been exceeded, if determined to limit waiting; and
an interface to backup memory for writing data relating to said command to backup memory, after said limit has been exceeded, if said limit has been exceeded;
wherein said interface to host is also configured to acknowledge success for said write command after said related data has been written to said backup memory.

21. The system of claim 20, further comprising:
an interface to primary memory for writing data relating to said command to said primary memory.

22. The system of claim 20, further comprising:
a special handling queue manager for queuing said command if there are too many commands whose limit has been exceeded and whose related data needs to be written to said backup memory, until there are no longer too many commands.

23. The system of claim 20, further comprising a locker/unlocker module for locking storage segments.

24. The system of claim 20, further comprising at least one primary memory storage entity and at least one backup memory storage entity.

25. The system of claim 24, wherein the amount of physical memory in said at least one primary memory storage entity equals the amount of physical memory in said at least one backup memory storage entity.

26. The system of claim 24, wherein said primary memory storage entity includes volatile memory further comprising: an uninterruptible power supply for powering said primary memory storage entity for a limited time after cessation of external power.

27. A computer readable medium having a computer readable code embodied therein for managing write commands in a storage system, the computer readable code comprising instructions for:
receiving a write command;
determining whether or not primary memory has sufficient vacancy to write data relating to said command;
if said primary memory does not have sufficient vacancy, then determining whether or not to limit waiting for vacancy to become sufficient; and
if determined to limit waiting and if said limit has been exceeded then after said limit has been exceeded:
writing data relating to said command to backup memory; and
acknowledging success for said write command after said data has been written to said backup memory.
